(19) United States
(12) Patent Application Publication
(10) Pub. No.: US 2026/0214188 A1
(43) Pub. Date: Jul. 23, 2026

(54) Electronic Vehicle Windshield Tint Projection Device

(71) Applicant: Larry Owens, Manassas, VA (US)

(72) Inventor: Larry Owens, Manassas, VA (US)

(21) Appl. No.: 19/455,906

(22) Filed: Jan. 22, 2026

Related U.S. Application Data
(60) Provisional application No. 63/747,944, filed on Jan. 22, 2025.

(51) Int. Cl. H04N 9/31; B60J 3/02; B60J 3/04

(52) U.S. Cl. CPC H04N 9/312; B60J 3/02; B60J 3/04; H04N 9/3182; H04N 9/3194

(57) ABSTRACT

An electronic vehicle windshield tint projection device is provided. The device is comprised of an electronic device configured to emit a semi-transparent tinted projection across the inner surface of a front windshield of a vehicle. More specifically, the device comprises a body housing a projector assembly, a control circuitry module, and a power interface. The projector assembly comprises a light modulation unit and a projection lens assembly capable of generating a wide-angle shaded projection adjustable in opacity, color, and spatial configuration on the windshield. The projection simulates the effect of a traditional sun visor but remains non-physical, enabling transparent visibility. Manual activation and configuration are provided through one or more control buttons, allowing users to toggle projection power, adjust tint hue and opacity of the projection, and reposition the projection to targeted regions of the windshield surface.

### CROSS-REFERENCE TO RELATED APPLICATION

The present application claims priority to, and the benefit of, U.S. Provisional Application No. 63/747,944, which was filed on Jan. 22, 2025, and is incorporated herein by reference in its entirety.

### FIELD OF THE INVENTION

The present invention relates generally to the field of vehicle sunshades. More specifically, the present invention relates to an electronic projection device configured to emit a semi-transparent, dynamically adjustable tinted projection across the inner surface of a vehicle windshield to reduce glare and solar heat without obstructing visibility. Accordingly, the present disclosure makes specific reference thereto. Nonetheless, it is to be appreciated that aspects of the present invention are also equally applicable to other like applications, devices, and methods of manufacture.

### BACKGROUND

Sunlight entering a vehicle through the windshield presents several functional challenges for drivers and passengers. More specifically, when a vehicle is parked under direct sunlight, the cabin temperature can rise significantly due to greenhouse effect, often reaching levels that pose discomfort or even potential health risks. Vehicle occupants may also experience physical discomfort from contact with heated surfaces such as seats, seatbelt buckles, and steering wheels. Additionally, prolonged exposure to sunlight accelerates the degradation of interior materials, including dashboard plastics and upholstery fabrics. During active driving, sunlight can also interfere with a driver's visual perception by creating glare or casting intense shadows, increasing the risk of traffic incidents. Traditional sun visors provide limited coverage and fixed angles, often failing to adequately address changing light conditions caused by the movement of the sun throughout the day. Window tints, while effective in some respects, are static and do not offer adjustable functionality based on immediate user preferences or environmental changes. Furthermore, not all window tinting solutions comply with local vehicle regulations, creating limitations for users seeking glare mitigation. As such, a versatile and responsive solution is needed to improve driver visibility and reduce solar heat gain in the vehicle cabin.

Therefore, there exists a long-felt need in the art for an electronic vehicle windshield tint projection device that dynamically adjusts to changing sunlight conditions. There also exists a long-felt need in the art for an electronic vehicle windshield tint projection device that reduces cabin temperature without physically modifying the windshield. Moreover, there exists a long-felt need in the art for an electronic vehicle windshield tint projection device that supplements or replaces traditional sun visors while maintaining clear driver visibility.

The subject matter disclosed and claimed herein, in one embodiment thereof, comprises an electronic vehicle windshield tint projection device. The device is comprised of an electronic device configured to emit a semi-transparent tinted projection across the inner surface of a front windshield of a vehicle. More specifically, the device comprises a body housing a projector assembly, a control circuitry module, and a power interface. The projector assembly comprises a light modulation unit and a projection lens assembly capable of generating a wide-angle shaded projection adjustable in opacity, color, and spatial configuration on the windshield. The projection simulates the effect of a traditional sun visor but remains non-physical, enabling transparent visibility. The control circuitry module receives input from an integrated light sensor configured to detect ambient lighting conditions and adjust parameters of the projection accordingly. A charging port allows the device to receive power through the existing onboard electrical system and ports of the vehicle. Manual activation and configuration are provided through one or more control buttons, allowing users to toggle projection power, adjust tint hue and opacity of the projection, and reposition the projection to targeted regions of the windshield surface.

In this manner, the electronic vehicle windshield tint projection device of the present invention accomplishes all the foregoing objectives and provides a dynamically adjustable shading solution that responds to variable light conditions. More specifically, the projection functionality reduces glare and helps maintain interior temperature without requiring physical alterations to the windshield, thereby addressing the problem of solar heat gain and driver discomfort. Through an adaptable control interface and light-responsive automation, the device further enhances safety by mitigating visual obstructions caused by sunlight, while offering users greater control than standard visors or static tints. As such, the device provides a flexible, compliance-friendly alternative to traditional glare-reducing mechanisms, improving comfort and visibility during vehicle operation and when parked.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electronic vehicle windshield tint projection device. The device is an electronic device configured to emit a tinted projection across the inner surface of a vehicle windshield for glare reduction and light intensity control within the vehicle cabin. More specifically, the projection emulates the function of a sun visor and may be dynamically adjusted in shape, size, position on the inner surface, and optical properties in response to changing light conditions.

The device may be mounted within the vehicle cabin at locations such as the rearview mirror assembly, dashboard, or overhead console. A fastener may secure the device body in place and is capable of maintaining stability during vehicle movement.

A projector assembly is mechanically attached to the device body and may be attached via a repositionable pivot point. The pivot point enables angular repositioning of the projector assembly to align the projection with a desired windshield region. A locking mechanism may be included to retain the projector assembly in a fixed position after adjustment.

The projector assembly comprises a projection lens assembly, a light modulation unit, and a control circuitry module. The projection lens assembly is configured to emit a semi-transparent, wide-angle tinted projection onto the inner surface of the windshield, forming a visible shaded region without physically altering the glass. The light modulation unit may employ technologies such as liquid crystal displays, digital light processing units, light-emitting diodes, or organic light-emitting diodes. The projection may have user-selectable opacity levels and colors, including gray, blue, amber, green, or bronze, each providing distinct optical characteristics. The control circuitry module regulates parameters of the projection, including spatial position, shape, opacity, color, intensity, and activation state. In one embodiment, a light sensor detects ambient lighting conditions near the windshield or within the cabin and is operatively connected to the control circuitry. The light sensor may automatically activate or adjust the projection based on ambient light levels and sun angle to maintain visibility and comfort.

An activation button allows manual power control of the light modulation unit. A second control button permits user adjustment of projection characteristics such as hue, opacity, and spatial dimensions. The projection may be constrained to a localized sun visor region or expanded to cover a broader windshield area. The second control button may toggle predefined presets or allow incremental adjustment of projection position and size.

Accordingly, the electronic vehicle windshield tint projection device of the present invention is particularly advantageous as it provides a dynamically adjustable shading solution that responds to variable light conditions. More specifically, the projection functionality reduces glare and helps maintain interior temperature without requiring physical alterations to the windshield, thereby addressing the problem of solar heat gain and driver discomfort. Through an adaptable control interface and light-responsive automation, the device further enhances safety by mitigating visual obstructions caused by sunlight, while offering users greater control than standard visors or static tints. In this manner, the device provides a flexible, compliance-friendly alternative to traditional glare-reducing mechanisms, improving comfort and visibility during vehicle operation and when parked while overcoming the limitations of existing devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of an electronic vehicle windshield tint projection device of the present invention in accordance with the disclosed architecture;

FIG. 2 illustrates a front perspective view of one potential embodiment of an electronic vehicle windshield tint projection device of the present invention in accordance with the disclosed architecture;

FIG. 3 illustrates a front view of one potential embodiment of an electronic vehicle windshield tint projection device of the present invention while positioned on a vehicle dash and while the projection is present on the inner surface of the vehicle windshield in accordance with the disclosed architecture; and

FIG. 4 illustrates a front view of one potential embodiment of an electronic vehicle windshield tint projection device of the present invention while positioned on a vehicle dash and while the projection is present on the inner surface of the vehicle windshield in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an electronic vehicle windshield tint projection device that dynamically adjusts to changing sunlight conditions. There also exists a long-felt need in the art for an electronic vehicle windshield tint projection device that reduces cabin temperature without physically modifying the windshield. Moreover, there exists a long-felt need in the art for an electronic vehicle windshield tint projection device that supplements or replaces traditional sun visors while maintaining clear driver visibility.

The present invention, in one exemplary embodiment, is comprised of an electronic vehicle windshield tint projection device. The device is configured to emit a tinted projection across the inner surface of a vehicle windshield to reduce glare and control light intensity within the vehicle cabin. During use, the projection simulates the functionality of a sun visor and may be dynamically adjusted in terms of shape, size, placement on the windshield surface, and optical characteristics in response to varying light conditions.

Mounting of the device within the vehicle cabin may occur at locations such as the rearview mirror assembly, dashboard, or overhead console. A fastener secures the device body at the selected location and is designed to maintain positional stability during normal vehicle operation. Mechanical attachment of a projector assembly to the device body is achieved via a repositionable pivot point, which allows for angular adjustment of the projector assembly to align the projection with a desired area on the windshield. A locking mechanism may be provided to secure the projector assembly in place following adjustment.

The projector assembly is comprised of a projection lens assembly, a light modulation unit, and a control circuitry module. The projection lens assembly is configured to cast a semi-transparent, wide-angle tinted projection onto the inner surface of the windshield, creating a visibly shaded region without physically altering the glass. The light modulation unit may incorporate technologies including liquid crystal displays, digital light processing units, light-emitting diodes, or organic light-emitting diodes. User-selectable options for opacity and color—such as gray, blue, amber, green, or bronze—allow the projection to deliver distinct optical effects. The control circuitry module manages key parameters of the projection, including position, shape, opacity, color, intensity, and activation state. A light sensor, operatively connected to the control circuitry, detects ambient lighting conditions near the windshield or within the vehicle cabin and may automatically trigger or adjust the projection in response to light level thresholds or sun angle changes, thereby enhancing visibility and occupant comfort.

Manual control of the device is enabled via an activation button that toggles the light modulation unit on or off. A second control button allows the user to modify projection attributes such as tint hue, opacity, and coverage area. The projection may be localized to a specific sun visor region or extended across a larger portion of the windshield. The second button may cycle through preset configurations or offer incremental adjustment of the projection's size and location.

In this manner, the device provides a dynamically adjustable shading solution that responds to variable lighting conditions. The projection further reduces glare and helps manage interior temperature without requiring physical modifications to the windshield, addressing issues related to solar heat gain and driver discomfort. Through the adaptive control interface and automated light response features, the device also improves visibility and safety, while offering enhanced functionality compared to conventional visors or fixed tints. As a result, the device delivers a flexible, regulation-compliant alternative to traditional glare-reduction methods, enhancing comfort during vehicle operation and while parked, and overcoming limitations associated with existing technologies.

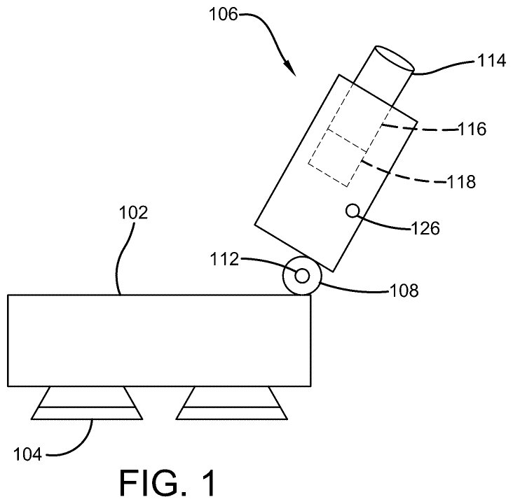

Referring initially to the drawings, FIG. 1 illustrates a side view of one potential embodiment of an electronic vehicle windshield tint projection device 100 of the present invention in accordance with the disclosed architecture. The device 100 is an electronic device that emits a tinted projection 110 across the inner surface 101 of a vehicle front windshield to mitigate glare and reduce light intensity within the vehicle cabin without requiring physical obstruction of the driver's view. In one embodiment, the projection 110 may simulate the function of a traditional sun visor while offering enhanced flexibility and precision in coverage. For example, the projection 110 may be dynamically adjusted in shape, size, position, and optical properties to match the movement of the sun or respond to varying light conditions. The device 100 may be configured for both aftermarket installation and integration during original vehicle manufacture, depending on the implementation.

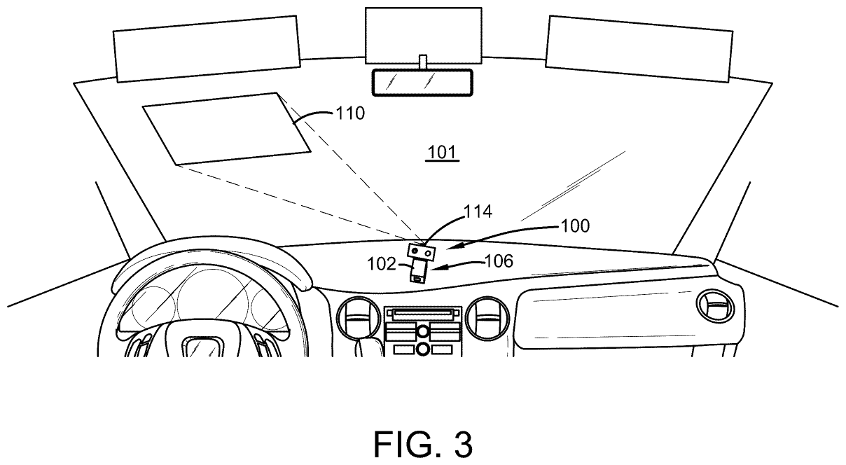

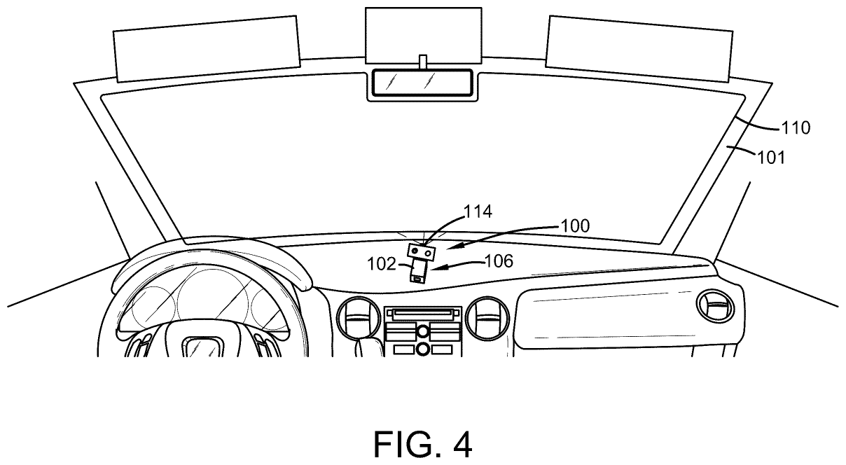

During operation, the device 100 may be positioned within the vehicle cabin, such as but not limited to at a mounting location adjacent to and/or on the rearview mirror assembly, dashboard (as seen in FIGS. 3-4), or overhead console. The body 102 of the device 100 may include at least one fastener 104, as seen in FIG. 1. The fastener 104 may be configured to secure the body 102 to the desired mounting location within the vehicle cabin. The fastener 104 may be comprised of but not limited to any combination of an adhesive pad, a suction cup, a mechanical clip, a magnet, or other attachment means suitable for maintaining the device 100 in a fixed orientation during typical vehicle operation, including vibrations and movement.

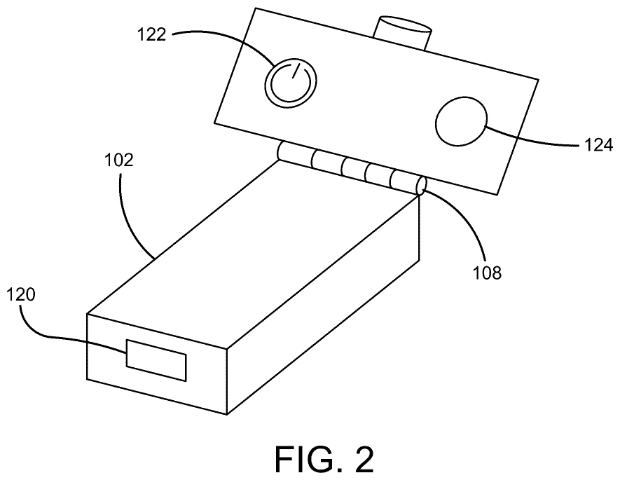

The device 100 is further comprised of a projector assembly 106. In one embodiment, the projector assembly 106 may be mechanically attached to the body 102 via at least one repositionable pivot point 108, as seen in FIG. 1 and FIG. 2. The pivot point 108 may be comprised of but not limited to any combination of a hinge, a ball-and-socket joint, a ratcheting swivel, or any multi-axis articulation mechanism. The pivot point 108 may allow for angular repositioning of the projection assembly 106 relative to the inner surface 101 of the windshield, enabling the user to align the projection 110 with a targeted region of the windshield. In one embodiment, the pivot point 108 may be further comprised of a locking mechanism 112, such as but not limited to a tension clamp, a toothed engagement interface, a spring-loaded detent, or a threaded locking collar, which may retain the projector assembly 106 in a fixed orientation after manual adjustment.

The projector assembly 106 may be comprised of a projection lens assembly 114, a light modulation unit 116, and a control circuitry module 118, as seen in FIG. 1. The projection lens assembly 114 may be configured to direct a wide-angle, semi-transparent tinted projection 110 that overlays at least a portion of (or in one embodiment, the entirety of) the inner surface 101 of the vehicle windshield. As such, the projection 110 may form a visibly shaded region on the surface 101, thus simulating the functional characteristics of a conventional sun visor or fixed window tint, while not physically adhering or modifying the windshield surface 101. Instead, the projection 110 may appear as a suspended and adjustable shaded overlay when viewed from within the vehicle cabin.

The light modulation unit 116 may be in the form of projection technologies such as but not limited to any combination of liquid crystal displays, digital light processing units, light-emitting diodes, organic light-emitting diodes. More specifically, the light modulation unit 116 may emit a tinted projection 110. In one embodiment, the projection 110 may have user-selectable levels of opacity and color such as but not limited to gray, blue, amber, green, or bronze. Each selectable hue may provide distinct optical properties suited to user preferences or varying lighting environments.

The control circuitry module 118 may be configured to regulate one or more functional parameters of the projection 110. Said parameters may include the spatial positioning of the projection 110 on the inner surface 101, as well as the shape, opacity, color, intensity, and activation state of the projection 110.

In one embodiment, the device 100 is further be comprised of a light sensor 126 configured to detect ambient lighting conditions within the vehicle cabin or in proximity to the vehicle windshield. The light sensor 126 may be operatively coupled to the control circuitry module 118 and may automatically activate or deactivate the light modulation unit 116 based on detected light levels above or below a threshold such as but not limited to when ambient light falls below 1,000 lux or exceeds 10,000 lux. Additionally, the light sensor 126 may be configured to adjust one or more parameters of the projection 110, such as but not limited to the opacity level and color selection of the projection 110, in response to changing external brightness levels or sun angle. This automated functionality may enhance visibility and driver comfort without requiring user intervention.

The device 100 may be powered via a charging port 120, as seen in FIG. 2. The charging port 120 may be comprised of a 3.5 mm power jack, a USB connector, or a combination thereof. The charging port 120 may be configured for direct interfacing with existing vehicle-integrated power outlets, such as but not limited to USB ports or auxiliary power ports, thereby enabling compatibility with a broad range of vehicle architectures and eliminating the need for intermediary adapters.

At least one activation button 122 may be provided on the device 100. The activation button 122 may allow the user to manually power the light modulation unit 116 on or off. Additionally, a second control button 124 may be included to allow for user selection or customization of one or more projection 110 characteristics, such as but not limited to tint hue, opacity strength, and size of the projection 110 on the inner surface 101. In one embodiment, the control button 124 may be configured to enable the user to reposition the projection 110 such that it is constrained to a localized sun visor area, for example, directly in front of the driver's field of view near the upper portion of the windshield, as seen in FIG. 3. In alternative configurations, the control button 124 may allow the projection 110 to be expanded or shifted to cover a broader region or substantially the entire inner surface 101 of the windshield, as seen in FIG. 4. The second control button 124 may be configured to toggle through a set of predefined spatial presets or, in other embodiments, may permit incremental control of the projection 110 dimensions and position across the windshield surface 101.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “electronic vehicle windshield tint projection device” and “device” are interchangeable and refer to the electronic vehicle windshield tint projection device 100 of the present invention.

Notwithstanding the foregoing, the electronic vehicle windshield tint projection device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the electronic vehicle windshield tint projection device 100 as shown in the FIGS. are for illustrative purposes only, and that many other sizes and shapes of the electronic vehicle windshield tint projection device 100 are well within the scope of the present disclosure. Although the dimensions of the electronic vehicle windshield tint projection device 100 are important design parameters for user convenience, the electronic vehicle windshield tint projection device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electronic vehicle windshield tint projection device comprising:
a body comprised of a projector assembly comprised of a projection lens assembly and a light modulation unit, wherein the projector assembly produces a tinted projection;
a fastener attached to the body; and
a control circuitry module configured to configure a parameter of the tinted projection.

2. The electronic vehicle windshield tint projection device of claim 1, wherein the fastener comprises an adhesive pad, a suction cup, a mechanical clip, or a magnet.

3. The electronic vehicle windshield tint projection device of claim 1 further comprised of a charging port.

4. The electronic vehicle windshield tint projection device of claim 1, wherein the parameter is comprised of a spatial positioning, a shape, a color, an opacity, an intensity, or an activation state.

5. The electronic vehicle windshield tint projection device of claim 4 further comprised of a button.

6. The electronic vehicle windshield tint projection device of claim 5, wherein the parameter is configurable via the button.

7. An electronic vehicle windshield tint projection device comprising:
a body comprised of a projector assembly comprised of a projection lens assembly and a light modulation unit, wherein the projector assembly produces a tinted projection;
a fastener attached to the body;
a light sensor; and
a control circuitry module configured to configure a parameter of the tinted projection.

8. The electronic vehicle windshield tint projection device of claim 7, wherein the light sensor activates and deactivates the projection assembly based on detecting an ambient light level threshold.

9. The electronic vehicle windshield tint projection device of claim 8, wherein the control circuitry module adjusts the parameter of the tinted projection based on detecting an ambient light level threshold.

10. The electronic vehicle windshield tint projection device of claim 7, wherein the light modulation unit is comprised of a liquid crystal display, a digital light processing unit, a light-emitting diode, or an organic light-emitting diode.

11. The electronic vehicle windshield tint projection device of claim 7, wherein the projection is comprised of a semi-transparent projection.

12. An electronic vehicle windshield tint projection device comprising:
a body comprised of a projector assembly attached to the body via a pivot point, wherein the projector assembly is comprised of a projection lens assembly and a light modulation unit;
wherein the projector assembly produces a tinted projection;
a fastener attached to the body;
a light sensor; and
a control circuitry module configured to configure a parameter of the tinted projection.

13. The electronic vehicle windshield tint projection device of claim 12, wherein the pivot point is comprised of a hinge, a ball-and-socket joint, a ratcheting swivel, or a multi-axis articulation mechanism.

14. The electronic vehicle windshield tint projection device of claim 13, wherein the pivot point is comprised of a locking mechanism.

15. The electronic vehicle windshield tint projection device of claim 12, wherein the light sensor activates and deactivates the projection assembly based on detecting an ambient light level threshold.

16. The electronic vehicle windshield tint projection device of claim 15, wherein the control circuitry module adjusts the parameter of the tinted projection based on detecting an ambient light level threshold.

17. The electronic vehicle windshield tint projection device of claim 12 further comprised of a button.

18. The electronic vehicle windshield tint projection device of claim 17, wherein the parameter is configurable via the button.

19. The electronic vehicle windshield tint projection device of claim 17, wherein the parameter is comprised of a spatial positioning, a shape, a color, an opacity, an intensity, or an activation state.

20. The electronic vehicle windshield tint projection device of claim 17, wherein the fastener comprises an adhesive pad, a suction cup, a mechanical clip, or a magnet.
